(19) United States
(12) Patent Application Publication
(10) Pub. No.: US 2009/0154464 A1
(43) Pub. Date: Jun. 18, 2009

(54) METHOD AND SYSTEM FOR SIMULATING NETWORK ADDRESS TRANSLATION

(75) Inventors: Jin Ryong KIM, Daejeon (KR); Ju Young Kim, Daejeon (KR); Chang Joon Park, Daejeon (KR); Kwang Ho Yang, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/336,226

(22) Filed: Dec. 16, 2008

(30) Foreign Application Priority Data
Dec. 17, 2007 (KR) 10-2007-0132347

(51) Int. Cl. H04L 12/56

(52) U.S. Cl. 370/392

(57) ABSTRACT

A system for simulating NAT (network address translation) performed in an internet protocol (IP) sharing device to be selectively operated in one of different network address translation (NAT) schemes includes a first network interface linking the IP sharing device with an internal network and a second network interface linking the IP sharing device with an external network. A Network Driver Interface Specification (NDIS) interface hooks packets incoming to the external network or outgoing from the internal network. A NAT unit has a mapping table and performs a network address translation of the hooked packets with reference to the mapping table, wherein the mapping table identifies IP addresses and port numbers of the packets to be translated by the NAT unit.

### CROSS-REFERENCE(S) TO RELATED APPLICATION(S)

The present application claims priority of Korean Patent Application No. 10-2007-0132347, filed on Dec. 17, 2007, which is incorporated herein by reference.

### FIELD OF THE INVENTION

The present invention relates to a network address translation (NAT) technology and, more particularly, to a method and system that simulate NAT performed in Internet Protocol (IP) sharing device so that P2P game developers can easily and thoroughly try out various NAT environments when developing P2P-based online game.

This work was supported by the IT R&D program of MIC/IITA [2006-S-044-02, Development of Multi-core CPU & MPU-Based Cross-Platform Game Technology].

### BACKGROUND OF THE INVENTION

As known in the art, NAT (network address translation) is a technique that maps an IP address space to another IP address space in the Internet Protocol (IP) layer, and is used to permit hosts in different IP address spaces to communicate with each other. NAT maps a single public IP address to multiple private IP addresses, securing many available IP addresses. Thus, IPv4 address shortage has resulted in wide adoption of NAT.

There are four NAT schemes: Full Cone, Restricted Cone, Port-Restricted Cone, and Symmetric. IP sharing devices may use one of the four NAT schemes.

In the Full Cone NAT scheme, all outgoing packets from an internal host are mapped to the same IP address and port. Hence, an external host can send packets to the internal host by sending packets to the mapped address.

In the Restricted Cone NAT scheme, all packets from the same internal IP address and port are mapped to the same external IP address and port. However, an external host can send packets to the internal host only when the internal host had previously sent a packet to the external host. In this case, the packet can be sent from the same external host regardless of the mapped external port.

The Port-Restricted Cone NAT scheme is similar to the restricted cone scheme, but has a further limitation on the port. An external host can send packets through a particular port to an internal host only when the internal host had previously sent a packet through the port to the external host. In this case, the packet can be sent only through the mapped particular port, and it is required to be the same host with the mapped IP address and port number.

The Symmetric NAT scheme is similar to the Port-Restricted Cone NAT scheme, but IP address and port of an internal host is mapped to a unique IP address and port of an external host.

In development of advanced online games, to distribute network traffic and to support speedy game environments, technology trends have shifted from the client-server architecture to the peer-to-peer (P2P) architecture. That is, many online games are based on P2P technology under User Datagram Protocol (UDP). Therefore, P2P communication is used for rapid real-time response during active gaming, and client-server communication is used for non real-time activities such as creation of cyber space for party play and purchase of in-game items.

However, NAT is a serious obstacle to application of P2P architecture. Address mapping between one public address and N private addresses may block packet exchange between peers.

To overcome this problem, many online game developers use UDP hole punching, or employ relay servers for sessions to which hole punching is not applied. UDP hole punching is employed to establish a P2P session. For example, assume that a server S is present and a client A desires to establish a UDP session directly with a client B. The client A connects to the server S, and the server S obtains IP address on the client A. The client B also connects to the server S, and the server S obtains IP address on the client B. The server S then sends A's IP information to the client B, and also sends B's IP address to the client A. Thus, the clients A and B can establish the UDP session with each other using the IP addresses. During this process, the server S can determine whether NAT is applicable, by comparing IP address sent by the client A or B with IP address contained in packets.

When UDP hole punching is not effective, the clients A and B communicate with each other through the server S. That is, the client A sends a message to the server S, which then forwards the message to the client B. The clients A and B can send and receive messages as long as they are connected to the server S. However, as described above, when most message exchange between clients is performed through a server, rapid real-time response cannot be obtained and waste of network bandwidth and server resources is caused. Particularly, when an IP sharing device operates in Full-Cone NAT scheme, an external host that has not ever been in communication with an internal host can connect to the internal host if it knows IP address of the IP sharing device and mapped port of the internal host, and hence P2P communication can be performed. In addition, when an IP sharing device operates in Restricted-Cone or Port-Restricted-Cone NAT scheme, P2P communication can be performed using UDP hole punching.

As described above, for sessions in which UDP hole punching is not effective, communication is performed through a relay server, causing waste of network bandwidth and server resources. For example, in the case when an IP sharing device operates in Symmetric NAT scheme, if the same internal host sends a packet with the same source address and port to a different external host, a newly mapped port is assigned to the IP sharing device and hence UDP hole punching is not effective. In this case, communication is performed through the relay server, which causes waste of resources.

To evaluate usefulness of a P2P-based online game under development, game developers tries out various IP sharing devices. However, many IP sharing devices implement different NAT schemes, making it extremely difficult for developers to thoroughly try out all types of IP sharing devices.

### SUMMARY OF THE INVENTION

It is, therefore, an object of the present invention to provide a method and system that simulate NAT performed in Internet Protocol (IP) sharing device so that P2P game developers can easily and thoroughly try out various NAT environments when developing P2P-based online game.

In accordance with an aspect of the present invention, there is provided a system for simulating NAT (network address translation) performed in an internet protocol (IP) sharing device, including:

a first network interface linking the IP sharing device with an internal network;

a second network interface linking the IP sharing device with an external network;

a Network Driver Interface Specification (NDIS) interface hooking packets incoming to the external network or outgoing from the internal network; and

a NAT unit having a mapping table and performing a network address translation on the hooked packets with reference to the mapping table, wherein the mapping table identifies IP addresses and port numbers of the packets to be translated by the NAT unit.

In accordance with another aspect of the present invention, there is provided a system for simulating NAT (network address translation) performed in an internet protocol (IP) sharing device, comprising:

a client application generating packets to be forwarded to an external network;

a network interface linking the IP sharing device with the external network;

a Network Driver Interface Specification (NDIS) interface hooking packets incoming from the external network; and

a NAT unit having a mapping table and performing a network address translation on the hooked packets with reference to the mapping table, wherein the mapping table identifies IP addresses and port numbers of the packets to be translated by the NAT unit.

In accordance with further another aspect of the present invention, there is provided a method of simulating NAT (network address translation) performed in an internet protocol (IP) sharing device selectively operable in one of different network address translation (NAT) schemes by using a mapping table which identifies IP addresses and port numbers of packet to be translated by the IP sharing device, the method comprising:

updating the mapping table depending on the one of different NAT schemes to be selectively operable by the IP sharing device;

hooking a packet from an application program;

performing the NAT of IP address and port number of the hooked packet with reference to the mapping table; and

forwarding the packet to the translated IP address and port number.

According to the present invention, simulation of communication between peers on networks can contribute to reduction of game development time, and facilitate testing of networking functions of a Windows-based application program to be run under various network environments.

### BRIEF DESCRIPTION OF THE DRAWINGS

The above and other objects and features of the present invention will become apparent from the following description of embodiments given in conjunction with the accompanying drawings, in which:

FIG. 1 is a block diagram illustrating a communication between a sender PC to a receiver PC of a related art;

FIG. 2 is a block diagram illustrating a simulation system in accordance with an embodiment of the present invention;

FIG. 3 is a block diagram illustrating a simulation system in accordance with another embodiment of the present invention;

FIG. 4 is a screen shot of a mapping table employed in the NAT unit shown in FIG. 2; and

FIG. 5 is a diagram depicting a packet delay simulation and a packet loss simulation performed in the NAT unit shown in FIG. 2.

### DETAILED DESCRIPTION OF THE EMBODIMENTS

Hereinafter, embodiments of the present invention will be described in detail with reference to the accompanying drawings so that they can be readily implemented by those skilled in the art.

Recent Windows operating systems have introduced Network Driver Interface Specification (NDIS) Intermediate filters residing in the kernel to enhance stability of networking functions and to permit various network-related operations.

To enable a network-related application program to readily emulate IP networks without code modification and recompilation, the present invention provides a NAT simulator in the form of an NDIS Intermediate Filter driver residing in the kernel of a Windows operating system. That is, with the NAT simulator residing in the kernel of a Windows operating system, it is expected that developers do not have to correct or modify their application programs to utilize simulation of IP sharing device environments.

The NAT simulator of the present invention carries out NAT schemes adopted in various IP sharing devices and configures settings specific to each IP sharing device (for example, keep-up time of a mapping table) to enable NAT simulation performed in IP sharing device environments.

The NAT simulator of the present invention can initiate NAT simulation performed in IP sharing device environments without an additional computer-based facility, and support network emulation in relation to packet delay and packet loss during the simulation.

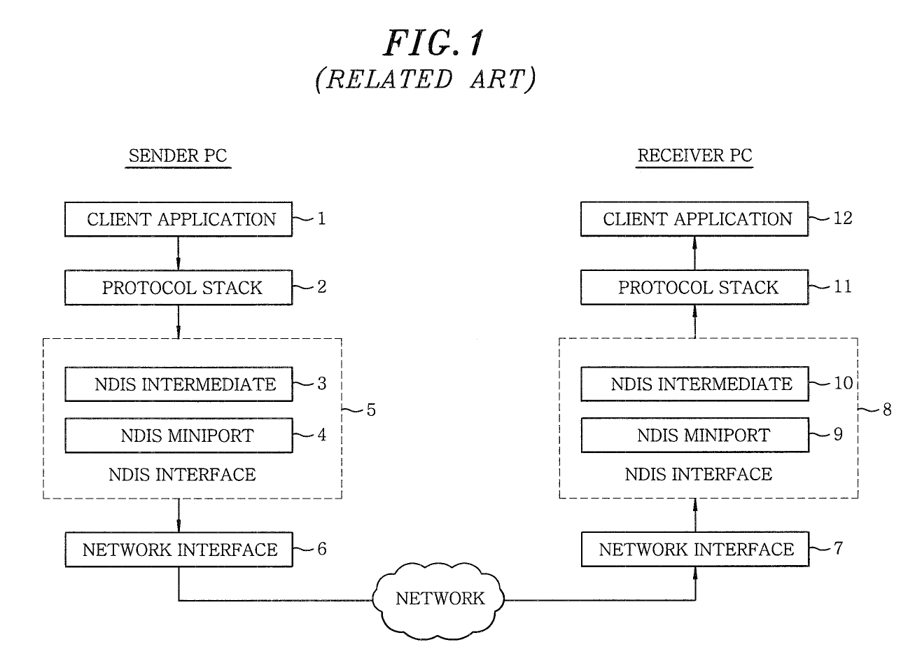

FIG. 1 shows a block diagram illustrating a P2P communication between a sender PC (personal computer) to a receiver PC of a related art. The communication between the sender PC to the receiver PC is described as follows.

As shown in FIG. 1, a client application 1 running in the user mode on the sender PC outputs user data to a protocol stack 2. The user data is encapsulated by the protocol stack 2 into packets with headers such as IP headers and TCP headers. The packets are sent through a network interface 6 over a global network to the receiver PC. The receiver PC receives these packets through a network interface 7, and decapsulates the packets using a protocol stack 11 into data without packet headers. Finally, the data is given to a client application 12 running on the receiver PC. During this process, the packets pass through an NDIS (Network Driver Interface Specification) interface 5 including an NDIS Intermediate 3 and an NDIS miniport 4 in the sender PC, and these packets pass through an NDIS interface 8 including an NDIS Intermediate 10 and an NDIS miniport 9 in the receiver PC.

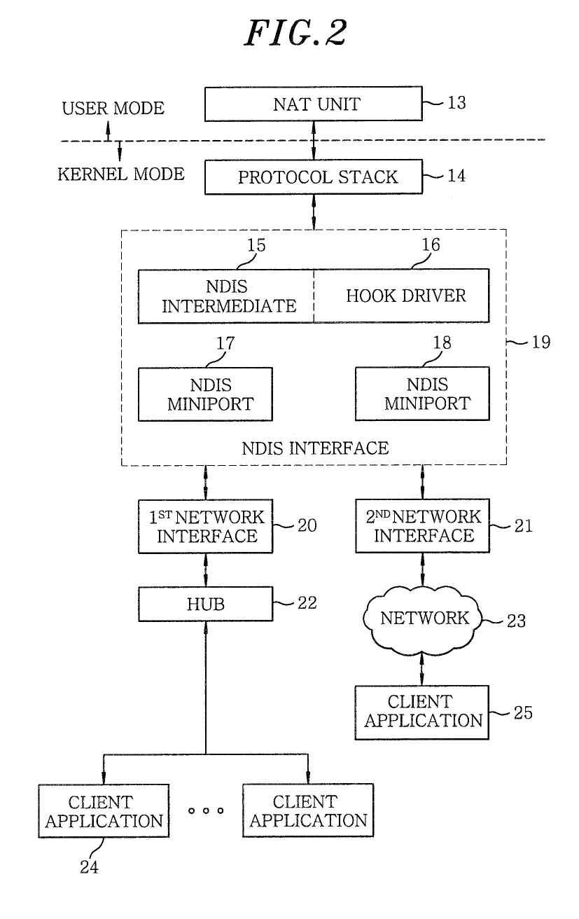

Referring now to FIG. 2, there is shown a block diagram illustrating a simulation system in accordance with an embodiment of the present invention.

As shown in FIG. 2, the simulation system includes a network address translation (NAT) unit 13 substantially acting to emulate various NAT environments, a protocol stack 14, an NDIS interface 19, and two network interfaces 20 and 21. Further, the NAT simulation system includes a hub 22, and multiple internal local PCs running client applications 24, which are connected to the hub 22.

According to the present invention, the simulation system serves to simulate an IP sharing device and can be implemented on a single physical PC operating in multi-modes using the two network interfaces 20 and 21.

A first network interface 20 is connected through the hub 22 with the local PCs running the client applications 24 such as game programs and allows the local PCs to link to a global network 23 through the IP sharing device. A second network interface 21 is connected to an external local PC running the same application program 25 and allows the local PC 26 to link the IP sharing device through a global network 23. That is, the first network interface 20 is used to connect the local PCs on a local network, e.g., LAN, to the global network 23 by using local IP addresses, and the second network interface 21 is used to connect the local PC 26 on the global network 23, e.g., the Internet, to the local network by using global IP addresses.

The NDIS intermediate 15 in a kernel mode is an intermediate layer capable of hooking outgoing and incoming packets, and includes a hook driver 16 to hook the packets and NDIS miniports 17 and 19 to interface the NDIS intermediate 15 and the respective network interfaces 20 and 21.

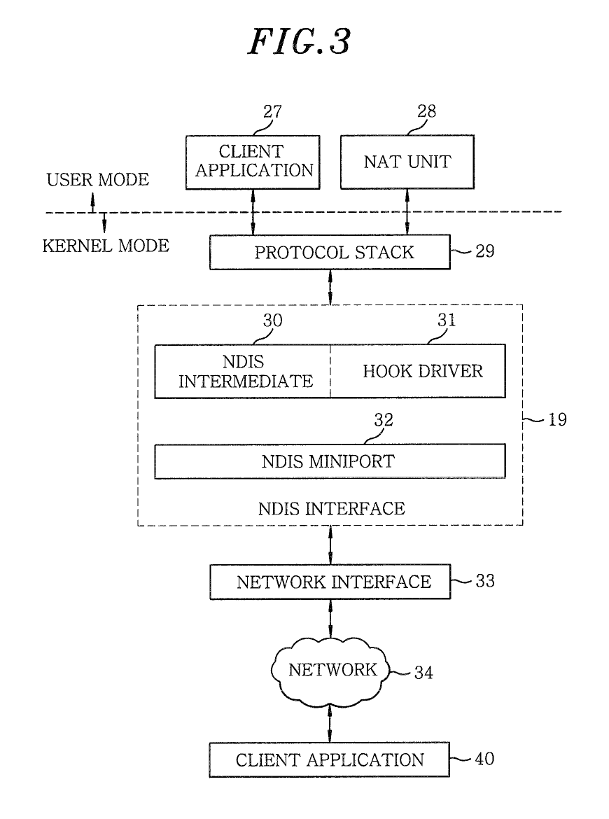

The NAT unit 13 operates in the user mode, and substantially emulates different NAT schemes such as Full Cone, Restricted Cone, Port Restricted Cone, and Symmetric. The NAT unit 13 includes a mapping table (see, FIG. 3) which identifies IP addresses and port numbers of the packets. The settings in the mapping table are configured depending on the respective NAT schemes to be simulated by the IP sharing device. The NAT unit 13 performs a network address translation on the packet hooked by the hook driver 16 using the mapping table, and sends the packet back to the hook driver 16.

For example, it is assumed that one of the NAT schemes, for example, Full-Cone NAT scheme, is now simulated. When a client application 24 on a local PC creates an outgoing packet that is to be sent to the global network 23, the packet is passed through the hub 22 and the first network interface 20 to an NDIS miniport 17 of the NDIS interface 19 associated with the first network interface 20. Then, the packet is transferred by the hook driver 16 to the NAT unit 13 bypassing the protocol stack 14. The NAT unit 13 translates IP address and port number of the packet according to the settings for the Full-Cone NAT scheme identified by searching for the mapping table, and transfers the translated packet back to the hook driver 16. Then, the translated packet is passed through the NDIS miniport 18 of the NDIS interface 19 and the second network interface 21 to the external local PC running the client application 25.

In return, when a client application 25 running on the external local PC desires to send a packet to the local network, the packet is passed through the second network interface 21 to the NDIS miniport 18 of the NDIS interface 19. Then, the packet is hooked by the hook driver 16 and transferred to the NAT unit 13 bypassing the protocol stack 14. The NAT unit 13 translates IP address and port number of the packet identified by searching for the mapping table and transfers the translated packet back to the hook driver 16. Then, the translated packet is passed through the NDIS miniport 17 of the NDIS interface 19, the first network interface 20 and the hub 22 to the internal local PC running the client application 24.

Accordingly, the NAT simulation system can simulate an IP sharing device, and implement four NAT schemes according to the settings in the mapping table.

FIG. 3 is a block diagram illustrating a simulation system in accordance with another embodiment of the present invention. In this regard, elements in FIG. 3 that are identical or similar to those in FIG. 2 will not be described.

Referring to FIG. 3, the simulation system includes an NAT unit 28 substantially acting to emulate different NAT environments, a protocol stack 29, an NDIS interface 39, and a network interface 33.

The simulation system of another embodiment serves to simulate an IP sharing device and can be implemented on a single physical PC operating in a single mode using one network interface 33.

Unlike the simulation system of the first embodiment in FIG. 2, it is noted that a client application 27, i.e., a game program is resident in the same layer as the NAT unit 28 (i.e., a user mode). It facilitates for a user to operate the NAT unit on the same physical PC on which the client program is running without installing the Nat unit into a separate PC. Those skilled in the art will appreciate that it is also possible to configure the client program to be run on a separate PC other than the PC executing the NAT unit.

For example, it is also assumed that one of the NAT schemes, for example, Full-Cone NAT scheme, is now simulated by the NAT unit 28.

In operation, when the client program 27 creates an outgoing data that is to be sent to the global network 34, the outgoing data is encapsulated by the protocol stack 29 into a packet with a header. The packet is passed through a hook driver 31 to the NAT unit 28.

As described before in connection with FIG. 2, the NAT unit 28 performs a network address translation on the hooked packet according to settings for the simulated NAT scheme identified by searching for a mapping table. However, only port number is translated and the IP address is unchanged. This is because only one network interface 33 is present in the simulation system and an IP address cannot be assigned thereto. The packet is then passed through the hook driver 31, an NDIS miniport 32, and the network interface 33 to a local PC 40 running the same client application.

In return, a packet generated from the local PC 40 arrives at the global network 34, the packet is passed through the network interface 33 to the NDIS miniport 32. Then, the packet is hooked by the hook driver 31 and transferred to the NAT unit 28. The NAT unit 28 translates port number of the hooked packet according to settings of a NAT scheme identified by searching the mapping table, and transfers the packet back to the hook driver 31. Then, the packet is decapsulated by the protocol stack 29 into data, which is then provided to the client program 27.

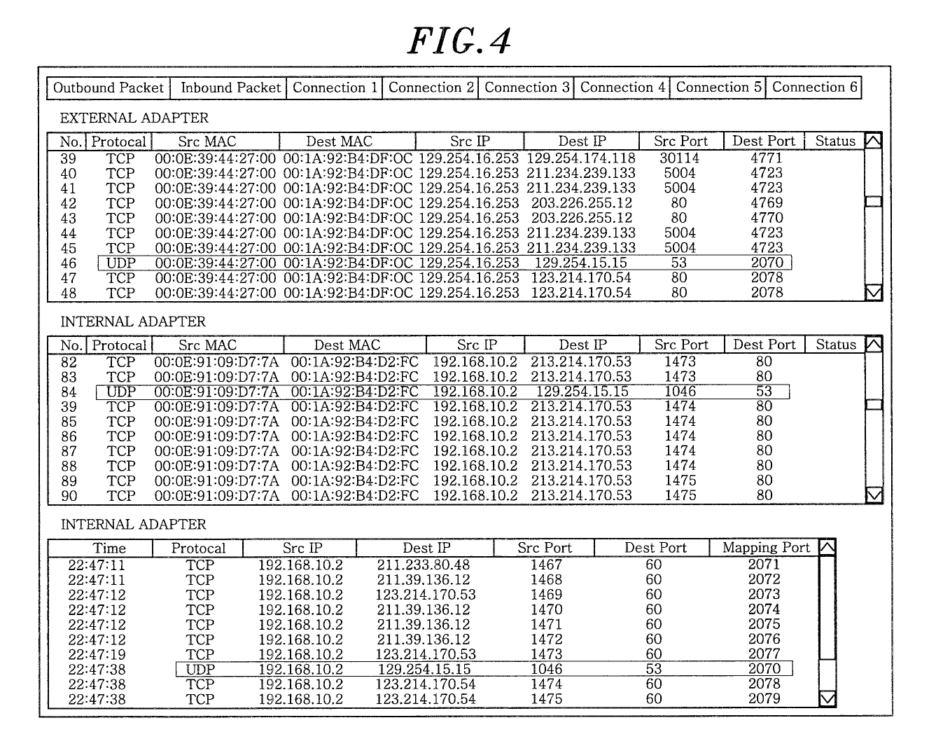

FIG. 4 is a screen shot of the mapping table employed in the NAT unit 13 of FIG. 2. In FIG. 4, “EXTERNAL ADAPTER” refers to the second network interface 21 of FIG. 2, and “INTERNAL ADAPTER” refers to the first network interface 20 of FIG. 2.

For example, assume that a packet with source IP address 129.254.15.15 and source port 53 travels through the global network 23 to the local PC 24 with IP address 192.168.10.2. When the packet arrives at the second network interface 21 with IP address 129.254.174.118 and port 2070, the packet is passed through the NDIS miniport 18, and hooked by the hook driver 16 and transferred to the NAT unit 13.

The NAT unit 13 searches “PORT MAPPING” in the mapping table for a mapping port ‘2070’, identifies IP address 192.168.10.2 and port 1046, and translates IP address and port of the packet. Subsequently, the packet is passed through the NDIS miniport 17 and the first network interface 20 to the local PC 24 having the final destination IP address.

The mapping table is updated depending on the one of the NAT schemes to be selectively operable. The settings in the mapping table are configured by a user for each NAT schemes, and the address and port is mapped with the settings corresponding to one of the NAT schemes to be simulated.

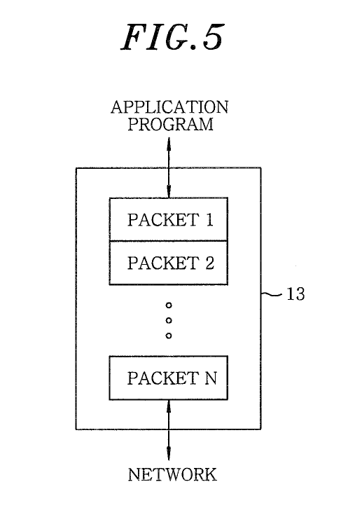

FIG. 5 is a diagram depicting an emulation of packet delay and packet loss which may aroused during NAT process in the NAT unit 13. For packet delay simulation, when packet 1 to packet n are present during the NAT process, the NAT unit 13 can delay the packet 1 to packet n for a preset time using, for example, a timer. For packet loss simulation, when packet 1 to packet n are present during the NAT process, the NAT unit 13 can randomly discard one or more of the packet 1 to packet n in response to a deletion signal.

As apparent from the above description, the present invention contributes to reduction of game development time through simulation of peer-to-peer communication environment, and enables easy testing of networking functions of Windows-based application programs in various networking environments.

While the invention has been shown and described with respect to the preferred embodiments, it will be understood by those skilled in the art that various changes and modifications may be made without departing from the spirit and scope of the invention as defined in the following claims.

What is claimed is:

1. A system for simulating NAT (network address translation) performed in an internet protocol (IP) sharing device, comprising:
a first network interface linking the IP sharing device with an internal network;
a second network interface linking the IP sharing device with an external network;
a Network Driver Interface Specification (NDIS) interface hooking packets incoming to the external network or outgoing from the internal network; and
a NAT unit having a mapping table and performing a network address translation on the hooked packets with reference to the mapping table, wherein the mapping table identifies IP addresses and port numbers of the packets to be translated by the NAT unit.

2. The system of claim 1, wherein the NDIS interface comprises:
a hook driver hooking the packet and transferring the hooked packet to the NAT unit; and
NDIS miniports interfacing the hook driver and the respective first and second network interfaces.

3. The system of claim 1, wherein the IP sharing device is selectively operable in one of different NAT schemes and the mapping table is updated depending on the one of the NAT schemes to be selectively operable.

4. The system of claim 3, wherein the NAT schemes includes Full Cone, Restricted Cone, Port Restricted Cone, and Symmetric NAT schemes.

5. The system of claim 1, the system is implemented on a single physical personal computer operating in multi-modes using the first and second network interfaces.

7. The system of claim 1, wherein the internal network comprising:
a hub connected to the first network interface; and
one or more local personal computers (PC) running a client application and generating the packet of the client application to be forwarded to the external network;
wherein the external network comprises a local PC running the same client application and generating the packet to be forwarded to the internal network.

8. A system for simulating NAT (network address translation) performed in an internet protocol (IP) sharing device, comprising:
a client application generating packets to be forwarded to an external network;
a network interface linking the IP sharing device with the external network;
a Network Driver Interface Specification (NDIS) interface hooking packets incoming from the external network; and
a NAT unit having a mapping table and performing a network address translation on the hooked packets with reference to the mapping table, wherein the mapping table identifies IP addresses and port numbers of the packets to be translated by the NAT unit.

9. The system of claim 8, wherein the NDIS interface comprises:
a hook driver hooking the packets and transferring the hooked packet to the NAT unit; and
an NDIS miniport interfacing the hook driver and the network interfaces.

10. The system of claim 8, wherein the IP sharing device is selectively operable in one of different NAT schemes, and the mapping table is updated depending on the one of the NAT schemes to be selectively operable.

11. The system of claim 10, wherein the NAT schemes includes Full Cone, Restricted Cone, Port Restricted Cone, and Symmetric NAT schemes.

12. The system of claim 8, the system is implemented on a single physical personal computer operating in single-mode using the network interface.

13. The system of claim 8, wherein the client application resides in the same layer as the NAT unit, and
wherein the external network comprises a local PC running the same client application and generating the packet to be forwarded to the NAT unit.

14. A method of simulating NAT (network address translation) performed in an internet protocol (IP) sharing device selectively operable in one of different network address translation (NAT) schemes by using a mapping table which identifies IP addresses and port numbers of packet to be translated by the IP sharing device, the method comprising:
updating the mapping table depending on the one of different NAT schemes to be selectively operable by the IP sharing device;
hooking a packet from an application program;
performing the NAT of IP address and port number of the hooked packet with reference to the mapping table; and
forwarding the packet to the translated IP address and port number.

15. The system of claim 14, wherein the NAT schemes includes Full Cone, Restricted Cone, Port Restricted Cone, and Symmetric NAT schemes.

16. The method of claim 14, further comprising performing a pack delay simulation and a packet loss simulation.
